(19) United States
(12) Patent Application Publication
(10) Pub. No.: US 2001/0025010 A1
(43) Pub. Date: Sep. 27, 2001

(54) Hydrocarbon-based fuel reforming catalyst and production method therefor

(75) Inventor: Takeshi Hirabayashi, Susono-shi (JP)

Correspondence Address: OLIFF & BERRIDGE, PLC, 277 S. WASHINGTON STREET, SUITE 500, ALEXANDRIA, VA, 22314, US

(73) Assignee: TOYOTA JIDOSHA KABUSHIKI KAISHA

(21) Appl. No.: 09/780,442

(22) Filed: Feb. 12, 2001

(30) Foreign Application Priority Data
Mar. 21, 2000 (JP) 2000-078068

(51) Int. Cl. B01J 23/34; B01J 23/10

(52) U.S. Cl. 502/324; 502/302; 423/652

(57) ABSTRACT

A hydrocarbon-based fuel reforming catalyst that suffers less capability deterioration and has excellent heat resistance and excellent durability is disclosed. The reforming catalyst includes CuOₓ/ZnO/ZrO₂/MnOₓ or CuOₓ/ZnO/ZrO₂/Y₂O₃ formed by adding manganese or yttrium to a reforming catalyst composed of copper, zinc and zirconium. If manganese is added, the ratio of manganese to the sum of manganese and zirconium (n/(Mn+Zr)) is from about 0.1 to about 0.62 and, preferably, about 0.17 to about 0.5, and the ratio of copper to the sum of copper and zinc (Cu/(Cu+Zn)) is from about 0.2 to about 0.6 and, preferably, about 0.3 to about 0.48. The reforming catalyst exhibits less capability deterioration and good durability in the steam reforming reaction of methanol.

### INCORPORATION BY REFERENCE

The disclosure of Japanese Patent Application No. HEI 12-078068 filed on Mar. 21, 2000 including the specification, drawings and abstract is incorporated herein by reference in their entirety.

### BACKGROUND OF THE INVENTION

1. Field of Invention

The invention relates to a hydrocarbon-based fuel reforming catalyst, and a production method for the reforming catalyst. More particularly, the invention relates to a reforming catalyst for use in the steam reforming reaction of a hydrocarbon-based fuel and a production method for the reforming catalyst and, more specifically, to a monolithic catalyst in which the hydrocarbon-based fuel reforming catalyst is coated.

2. Description of Related Art

As a conventional hydrocarbon-based fuel reforming catalyst of the aforementioned type, a reforming catalyst formed by a compound that contains copper, zinc and zirconium as main components has been proposed (in, for example, Japanese Patent Application Laid-Open No. HEI 10-272360). It is considered that the reforming catalyst formed by a compound that contains copper, zinc and zirconium as main components has high strength and excellent heat resistance, and enables an efficient reforming reaction of methanol.

However, where a copper-zinc-zirconium-based reforming catalyst is used, a very small amount of acetic acid (CH₃COOH in chemical formula) and the like is formed during the steam reforming reaction of methanol. Acetic acid reacts with copper (Cu) contained in the reforming catalyst, forming copper acetate (Cu(CH₃COO)₂). Copper acetate reduces the reforming capability of the reforming catalyst in some cases. Furthermore, when exposed to high temperature, the reforming catalyst may exhibit poor durability.

### SUMMARY OF THE INVENTION

Accordingly, it is an object of the invention to reduce the capability deterioration and improve durability in a reforming catalyst for a hydrocarbon-based fuel.

A reforming catalyst for a hydrocarbon-based fuel in accordance with the invention is a reforming catalyst for use in a steam reforming reaction of hydrocarbon-based fuel. The reforming catalyst includes at least one of manganese and yttrium contained in a compound that contains copper, zinc and zirconium as main components.

In the hydrocarbon-based fuel reforming catalyst of the invention, at least one of manganese and yttrium is contained in the compound containing copper, zinc and zirconium as main components. It is considered that acetic acid and the like formed in a very small amount in the steam reforming reaction of a hydrocarbon-based fuel, in particular, of methanol, degrade the capability and durability of the reforming catalyst. However, at least one of manganese and yttrium contained in the catalyst can decompose acetic acid or the like. That is, because acetic acid or the like, which causes deteriorations in the capability and durability of the reforming catalyst, can be reduced or eliminated, the capability and durability of the reforming catalyst can be improved.

A production method for a reforming catalyst for use in a steam reforming reaction of a hydrocarbon-based fuel in accordance with the invention comprises a mixing and synthesizing step of forming a mixed oxide material containing oxides of copper, zinc and zirconium and at least one of an oxide of manganese and an oxide of yttrium.

The production method for a reforming catalyst for a hydrocarbon-based fuel of the invention can produce a hydrocarbon-based fuel reforming catalyst that is excellent in the capability and durability of the reforming catalyst.

### BRIEF DESCRIPTION OF THE DRAWINGS

The above and other objects, features, advantages, and technical and industrial significance of this invention will be better understood by reading the following detailed description of presently preferred embodiments of the invention, when considered in connection with the accompanying drawing, in which:

FIG. 1 is a diagram indicating exemplary experimental results of an initial evaluation and a durability evaluation with regard to methanol reforming catalysts of Examples 1 and 2 and methanol reforming catalysts of Comparative Examples 1 and 2;

FIG. 2 is a diagram indicating an example of the relationship between the methanol reforming ratio and the distribution between manganese and zirconium; and

FIG. 3 is a diagram indicating an example of the relationship between the methanol reforming ratio and the distribution between copper and zinc.

### DETAILED DESCRIPTION OF PREFERRED EMBODIMENTS

In the following description and the accompanying drawings, the present invention will be described in more detail with reference to specific embodiments.

First, terms used herein will be explained. The term “reforming” means the changing of the composition of a hydrocarbon-based compound by the effect of heat or a catalyst. The term “steam reforming” means the changing of the composition of a hydrocarbon-based compound by mixing the hydrocarbon-based compound with water and subjecting the mixed gas of the hydrocarbon-based compound and steam of the water to the effect of heat or a catalyst. The term “monolithic catalyst” means a catalyst having gas channels that have a mesh sectional shape and that extend parallel in a direction of an axis and are separated from one another by thin walls. Due to its honeycomb shape, the catalyst is also termed “honeycomb catalyst”. The term “mix and synthesize” means to mix a plurality of compounds and form one or more compounds different from the material compounds. The term “precursor” means a substance at a stage prior to obtaining a product through chemical reactions. When used in the description below, the term “precursor” refers to a substance at a stage where a plurality of compounds have been mixed but no oxide has been formed. The term “liquid hourly space velocity (LHSV)” means a value obtained by dividing the volume of a liquid flowing through a space within a substance per hour by the volume of the space of the substance. The term “sintering” means growth of particles by smaller particles sticking to one another and therefore forming larger particles.

An exemplary embodiment of the invention will be described with reference to examples.

A. MIXTURE AND SYNTHESIS OF METAL REFORMING CATALYST OF EXAMPLES AND METHANOL REFORMING CATALYST OF COMPARATIVE EXAMPLES

(1) Methanol Reforming Catalyst of Example 1

A CuOₓ/ZnO/ZrO₂/MnOₓ precursor was obtained by dissolving predetermined amounts of Cu(NO₃)₂•3H₂O, Zn(NO₃)₂•6H₂O, ZrO(NO₃)₂2H₂O and Mn(NO₃)₂•6H₂O in distilled water and then dripping a predetermined amount of a Na₂CO₃ aqueous solution into this solution. The former predetermined amounts were about 60 grams, and the latter predetermined amount was about 25 grams. The predetermined amounts may be increased or decreased, that is, the predetermined amounts may be determined in accordance with the required amount of a reforming catalyst, as long as the ratio therebetween remains unchanged. However, the aforementioned ratio is not limited to the above-indicated ratio, but may be within a range that includes ratios slightly different from the aforementioned ratio. After the precursor solution, including the supernatant, was heated at 70° C. for 30 minutes, washing and filtration were repeatedly performed. Then, resultant sediment was dried at 120° C. for at least 24 hours. This filtering process removes sodium ions through dissolution into water, and that serves to extract powder after the removal of sodium ions. The dried powder was baked at 350° C. for 2 hours, thereby providing a methanol reforming catalyst of CuOₓ/ZnO/ZrO₂/MnOₓ of Example 1.

The process of heating at 75° C. for 30 minutes prior to the washing and filtering process is not restrictive. For example, the heating temperature may be any temperature within the range of about 70 to about 90° C. The heating duration may be any duration within the range of about 20 to about 60 minutes. The drying temperature may be any temperature within the range of about 100 to about 150° C. The drying duration may be reduced to about several hours, or may be increased beyond about 24 hours, without causing any problem. The baking temperature is not limited to 350° C., but may be any temperature within the range of about 200 to about 700° C. The baking duration is not limited to 2 hours, but may be any duration within the range of about 1 to about 3 hours. As long as the conditions are within the aforementioned ranges, methanol reforming catalysts of substantially equal qualities can be provided.

(2) Methanol Reforming Catalyst of Example 2

A methanol reforming catalyst of Example 2 of CuOₓ/ZnO/ZrO₂/Y₂O₃ was obtained by substantially the same method as that employed in the mixture and synthesis of the methanol reforming catalyst of Example 1, except that Y(NO₃)₃•6H₂O was used instead of M(NO₃)₂•6H₂O.

(3) Methanol Reforming Catalyst of Comparative Example 1

A methanol reforming catalyst of Comparative Example 1 of CuOₓ/ZnO/ZrO₂ was obtained by substantially the same method as that employed in the mixture and synthesis of the methanol reforming catalyst of Example 1, except that Mn(NO₃)₂•6H₂O was not added.

(4) Methanol Reforming Catalyst of Comparative Example 2

A methanol reforming catalyst of Comparative Example 2 of CuOₓ/ZnO/Al₂O₃ was obtained by substantially the same method as that employed in the mixture and synthesis of the methanol reforming catalyst of Comparative Example 1, except that Al (NO₃)₃•9H₂O was used instead of ZrO(NO₃)₂•2H₂O.

B. EVALUATION METHOD AND EVALUATION

(1) Initial Evaluation Method

The methanol reforming catalysts of Examples 1 and 2 and the methanol reforming catalysts of Comparative Examples 1 and 2 described above were subjected to the steam reforming of methanol in the following manner. A mixture gas was prepared in which the ratio of the mole number of water to the mole number of methanol (H₂O/CH₃OH) was 2.0 and the ratio of the number of oxygen atoms to the number of carbon atoms present in methanol (O/C) was 0.23. The mixture gas was caused to flow into each methanol reforming catalyst to perform the steam reforming of methanol present in the mixture gas. The steam reforming of methanol was performed by setting up a condition where the liquid hourly space velocity (LHSV) with respect to methanol in conversion to liquid was 2.0 [l/h] and the temperature of the mixture gas at a position immediately before entering the methanol reforming catalyst was 250° C.

(2) Durability Evaluation Method

With respect to each one of the methanol reforming catalysts of Examples 1 and 2 and the methanol reforming catalysts of Comparative Examples 1 and 2, the steam reforming of methanol is performed as follows. The same mixture gas as that used for the initial evaluation was caused to flow into the methanol reforming catalyst to perform the steam reforming of methanol present in the mixture gas. For the steam reforming of methanol, a condition was established where the liquid hourly space velocity (LHSV) with respect to methanol in conversion to liquid was 2.0 [l/h] and the temperature of the mixture gas at a position immediately before entering the methanol reforming catalyst was 350° C. Under this condition, the steam reforming of methanol was performed for 60 hours. Then, the same mixture gas was subjected to the steam reforming of methanol at a condition of the liquid hourly space velocity (LHSV) being the same as mentioned above and an inlet temperature of the mixture gas being 250° C.

(3) Evaluation

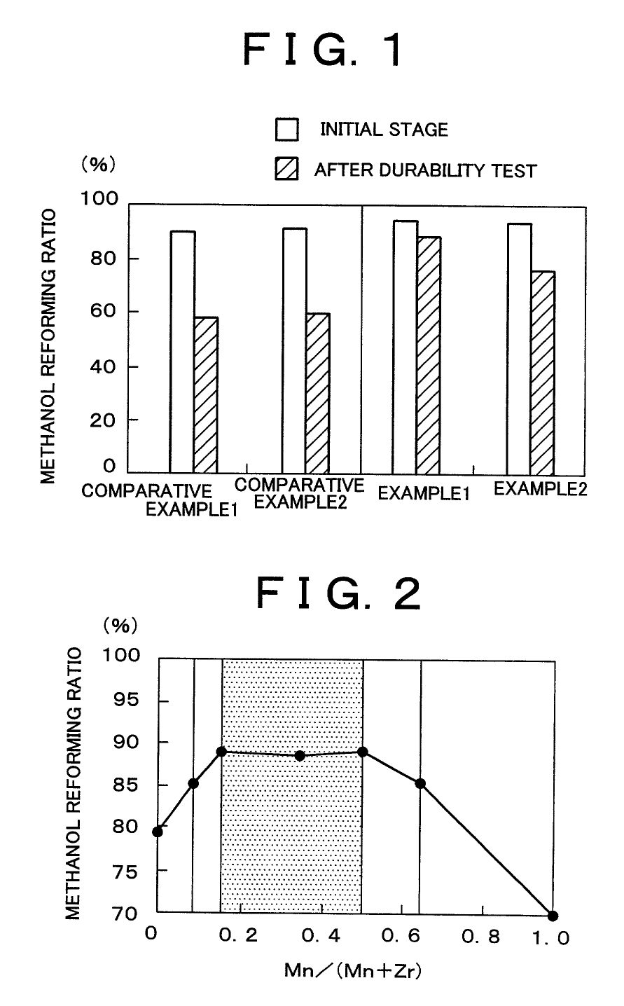

Experimental results obtained by the initial evaluation method and the durability evaluation method described above are indicated in FIG. 1. As is apparent from FIG. 1, the methanol reforming catalysts of Examples 1 and 2 both exhibited at least as high of a methanol reforming ratio as the methanol reforming catalysts of Comparative Examples 1 and 2 in the initial evaluation.

In the durability evaluation, the methanol reforming catalysts of Examples 1 and 2 both exhibited higher methanol reforming ratios than the methanol reforming catalysts of Comparative Examples 1 and 2. In particular, the methanol reforming catalyst of Example 1 exhibited better durability than the methanol reforming catalyst of Example 2. A cause for the exhibition of relatively good durability of the methanol reforming catalysts of Examples 1 and 2 in the durability evaluation is considered that manganese and yttrium decompose acetic acid and the like at lower temperatures, that are within the temperature range for the steam reforming reaction, than the temperatures in which copper, aluminum, zirconium and aluminum decompose acetic acid and the like. It should be noted herein that acetic acid and the like are produced as by-products in very small amounts in the steam reforming reaction of methanol. Acetic acid thus produced reacts with copper (Cu) present in the methanol reforming catalyst, thereby forming copper acetate (Cu(CHCOO)₂). The copper acetate is considered to reduce the catalytic capability of the methanol reforming catalyst.

C. Preferred Ranges of Components of Methanol Reforming Catalyst of Example 1

As described above, the methanol reforming catalyst of Example 1 exhibited good results in the initial evaluation and the durability evaluation. Preferred ranges of components of the methanol reforming catalyst of Example 1 will be considered below.

(1) Distribution between Manganese and Zirconium

Based on experiments using methanol reforming catalysts of Example 1 having a mole ratio of Cu:Zn:(Mn+Zr)=1.0:1.0:0.56, the relationship between the ratio of manganese to the sum of manganese and zirconium (Mn/(Mn+Zr)) and the methanol reforming ratio was considered. The experiment was performed by the same method as the initial evaluation method. Results of the experiment are indicated in FIG. 2. As indicated in FIG. 2, good methanol reforming ratios were exhibited where the ratio of manganese to the sum of manganese and zirconium (Mn/(Mn+Zr)) was within the range of about 0.1 to about 0.62, and still better methanol reforming ratios were exhibited where the ratio was within the range of about 0.17 to about 0.5.

(2) Distribution between Copper and Zinc

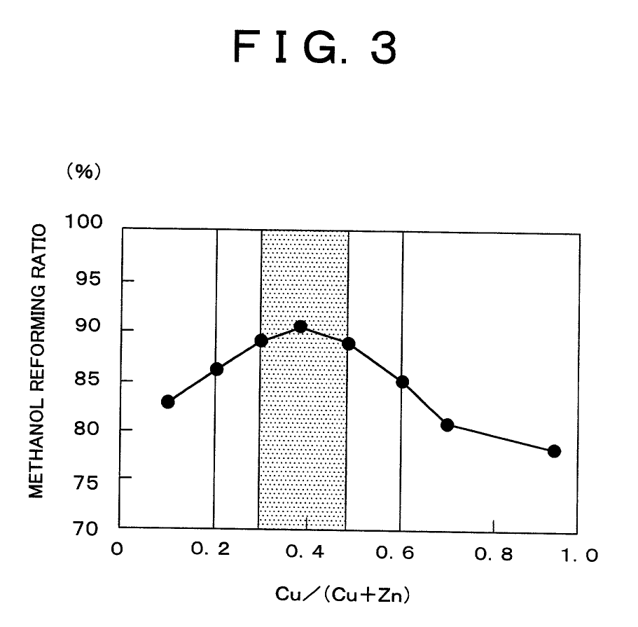

Based on experiments using methanol reforming catalysts of Example 1 having a mole ratio of (Cu+Zn): Zr:Mn=2.1:0.28:0.28, the relationship between the ratio of copper to the sum of copper and zinc (Cu/(Cu+Zn)) and the methanol reforming ratio was considered. The experiment was performed by the same method as the initial evaluation method. Results of the experiment are indicated in FIG. 3. As indicated in FIG. 3, good methanol reforming ratios were exhibited where the ratio of copper to the sum of copper and zinc (CU/(Cu+Zn)) was within the range of about 0.2 to about 0.6, and still better methanol reforming ratios were exhibited where the ratio was within the range of about 0.3 to about 0.48.

D. Effects of Hydrogen-reduction of Methanol Reforming Catalysts

The methanol reforming catalysts of Examples 1 and 2 obtained by the above-described mixture and synthesis were subjected to reduction by hydrogen at a temperature of 200 to 400° C. Even if not subjected to hydrogen reduction, the methanol reforming catalysts of Examples 1 and 2 are able to function as a methanol reforming catalyst as mentioned above. In some cases, however, the methanol reforming catalysts may undergo sintering with a sharp temperature rise at the start of use of the catalysts. The methanol reforming catalysts of Examples 1 and 2 subjected to hydrogen reduction do not undergo a sharp temperature rise at the start of use of the catalysts, and therefore do not undergo sintering. It is considered that the sharp temperature rise at the start of use of a catalyst is based on a phenomenon where methanol as a reforming material extracts oxygen from the catalyst as an oxide, and reacts with oxygen. Therefore, it is considered that the hydrogen reduction prevents such reactions.

Although in Examples 1 and 2, the methanol reforming catalysts obtained after baking were immediately used without being processed any further, the methanol catalysts of Examples 1 and 2 may be coated on surfaces of a monolithic honeycomb, such as a honeycomb tube or the like, and therefore may be formed as monolithic catalysts. Thus, the degree of freedom in designing the contact area per unit volume is increased, so that the steam reforming of methanol can be more efficiently performed.

Although in Examples 1 and 2, the methanol reforming catalysts were used as catalysts for reforming methanol by using steam, the catalyst may also be used as catalysts for the steam reforming of hydrocarbon-based fuels other than methanol, for example, saturated hydrocarbon-based fuels, such as methane, ethane, and the like; unsaturated hydrocarbon-based fuels, such as ethylene, propylene, and the like; and other alcohols, such as ethanol and the like.

Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

What is claimed is:

1. A reforming catalyst for use in a steam reforming reaction of a hydrocarbon-based fuel, comprising:
a compound containing copper, zinc and zirconium as main components; and
manganese.

2. The reforming catalyst according to claim 1, wherein a ratio of a mole number of manganese to a mole number of a sum of manganese and zirconium is within a range of about 0.1 to about 0.62.

3. The reforming catalyst according to claim 1, wherein a ratio of a mole number of manganese to a mole number of a sum of manganese and zirconium is within a range of about 0.17 to about 0.5.

4. The reforming catalyst according to claim 1, wherein a ratio of a mole number of copper to a mole number of a sum of copper and zinc is within a range of about 0.2 to about 0.6.

5. The reforming catalyst according to claim 1, wherein a mole ratio of copper to a mole number of a sum of copper and zinc is within a range of about 0.3 to about 0.48.

6. A monolithic catalyst comprising a reforming catalyst for a hydrocarbon-based fuel according to claim 1 coated on a surface of a monolithic honeycomb.

7. A monolithic catalyst comprising a reforming catalyst for a hydrocarbon-based fuel according to claim 2 coated on a surface of a monolithic honeycomb.

8. A monolithic catalyst comprising a reforming catalyst for a hydrocarbon-based fuel according to claim 4 coated on a surface of a monolithic honeycomb.

9. A reforming catalyst for use in a steam reforming reaction of a hydrocarbon-based fuel, comprising:
a compound containing copper, zinc and zirconium as main components; and
yttrium.

10. A monolithic catalyst comprising a reforming catalyst for a hydrocarbon-based fuel according to claim 9 coated on a surface of a monolithic honeycomb.

11. A production method for a reforming catalyst for a hydrocarbon-based fuel, comprising:
forming an oxide of copper, an oxide of zinc, an oxide of zirconium, and an oxide of manganese; and
mixing the oxide of copper, the oxide of zinc, the oxide of zirconium, and the oxide of manganese to obtain a mixed oxide.

12. The production method according to claim 11, further comprising baking the mixed oxide at a temperature of about 200 to about 700° C.

13. The production method according to claim 12, wherein the mixed oxide is baked for about 1 to about 3 hours.

14. The production method according to claim 12, further comprising:
washing and filtering the mixed oxide by maintaining the mixed oxide at a temperature of about 70 to about 90° C. for about 20 to about 60 minutes;
repeating the washing filtering;
then baking the mixed oxide; and
drying the mixed oxide material obtained by the washing and filtering by maintaining the mixed oxide at a temperature of from about 100 to about 150° C.

15. The production method according to claim 12, further comprising hydrogen-reducing the mixed oxide material after baking at a temperature of about 200 to about 400° C.

16. A production method for a reforming catalyst for a hydrocarbon-based fuel, comprising:
forming an oxide of copper, an oxide of zinc, an oxide of zirconium, and an oxide of yttrium; and
mixing the oxide of copper, the oxide of zinc, the oxide of zirconium, and the oxide of yttrium to obtain a mixed oxide.

17. The production method according to claim 16, further comprising baking the mixed oxide at a temperature of about 200 to about 700° C.

18. The production method according to claim 17, wherein the mixed oxide material is baked for about 1 to about 3 hours.

19. The production method according to claim 17, further comprising:
washing and filtering the mixed oxide by maintaining the mixed oxide at a temperature of about 70 to about 90° C. for about 20 to about 60 minutes;
repeating the washing and filtering;
then baking the mixed oxide; and
drying the mixed oxide obtained by the washing and filtering by maintaining the mixed oxide at a temperature of about 100 to about 150° C.

20. The production method according to claim 17, further comprising hydrogen-reducing the mixed oxide after baking at a temperature of about 200 to about 400° C.
